(19) United States
(12) Patent Application Publication
(10) Pub. No.: US 2009/0144541 A1
(43) Pub. Date: Jun. 4, 2009

(54) METHOD AND APPARATUS OF MUTUAL AUTHENTICATION AND KEY DISTRIBUTION FOR DOWNLOADABLE CONDITIONAL ACCESS SYSTEM IN DIGITAL CABLE BROADCASTING NETWORK

(76) Inventors: Soon Choul KIM, Daejeon (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/273,599

(22) Filed: Nov. 19, 2008

(30) Foreign Application Priority Data
Dec. 3, 2007 (KR) 10-2007-0124225

(51) Int. Cl. H04L 9/28; H04L 9/00; G06F 9/445

(52) U.S. Cl. 713/156; 717/178

(57) ABSTRACT

A method and apparatus of X.509 certificate-based mutual authentication and key distribution for a Downloadable Conditional Access System (DCAS) in a digital cable broadcasting network is provided for composing a software-based secure DCAS in various Conditional Access Systems (CASs) based on an embodiment form of Conditional Access (CA) application for CA of digital cable broadcasting.

### CROSS-REFERENCE TO RELATED APPLICATION

This application claims priority from Korean Patent Application No. 10-2007-0124225, filed on Dec. 3, 2007, in the Korean Intellectual Property Office, the entire disclosure of which is incorporated herein by reference.

### BACKGROUND OF THE INVENTION

1. Field of the Invention

The present invention relates to a mutual authentication method in a cable broadcasting network supporting two-way communication, and more particularly, to an X.509 certificate-based mutual authentication and key distribution method for a Downloadable Conditional Access System (DCAS) in a digital cable broadcasting network.

This work was supported by the IT R&D program of MIC/IITA [2007-S-007-01, The Development of Downloadable Conditional Access System].

2. Description of Related Art

Various Conditional Access Systems (CASs) are currently used based on an embodiment form of Conditional Access (CA) application for CA of digital cable broadcasting, however, a cable card of either a smart card form or a Personal Computer Memory Card International Association (PCMCIA) card form is generally used. Since a predetermined time is required for card reissuance when a CAS defect occurs, by distribuiting CAS operating software (CAS Client) offline using either the smart card or the PCMCIA card, there is a disadvantage that a quick measure is difficult and an additional cost for card reissuance occurs. A software-based downloadable CAS (DCAS) has been recently disclosed in order to overcome the disadvantage. For this, related technology development is under way.

However, since security vulnerability occurring based on a characteristic of on-line mutual authentication and a software transmission scheme may be a problem in a downloadable software CAS, a measure with respect to this is required.

### SUMMARY OF THE INVENTION

An aspect of the present invention provides a software-based Downloadable Conditional Access System (DCAS) for Conditional Access (CA) of current digital cable broadcasting which can distribute a Conditional Access System (CAS) operating software (CAS Client) offline using a smart card or a Personal Computer Memory Card International Association (PCMCIA) card, thereby solving disadvantages that a quick measure is difficult due to a predetermined time required for card reissuance when a CAS defect occurs and an additional cost for card reissuance occurs.

Another aspect of the present invention also provides a method and apparatus of mutual authentication and key distribution for a DCAS in a digital cable broadcasting network which can overcome a security vulnerability occurring based on a characteristic of on-line mutual authentication between systems and a software transmission scheme.

Another aspect of the present invention also provides a method and apparatus of mutual authentication and key distribution for a DCAS in a digital cable broadcasting network which can immediately reflect period expiration of a certificate for mutual authentication disclosed for reliable security or other certificate revocation cause occurrences, thereby verifying validity of a Secure Micro (SM) certificate simultaneously and frequently occurring, and enabling real-time mutual authentication based on newest information.

According to an aspect of the present invention, there is provided a method of controlling a DCAS SM in an X.509 certificate-based mutual authentication and key distribution method for a DCAS in a digital cable broadcasting network, the method including: generating, by the DCAS SM, a public key and a private key as one pair, using a specific algorithm; requesting a Trusted Authority (TA) to issue an SM certificate via a secure communication channel of an Authentication Proxy (AP) Server using the generated keys; verifying whether the SM certificate issued from the TA via the secure communication channel is forged or altered using a TA certificate included in the DCAS SM; transmitting an SM authentication request message to the AP server based on the SM certificate for which the verifying is completed; and comparing first AP server identification information and second AP server identification information included in the SM certificate issued from the TA and verifying whether the first and second AP server identification information are the same using an SM authentication response message received from the AP server.

According to another aspect of the present invention, there is provided a method of controlling an AP server, the method including: generating, by the AP server, a secure communication channel with a TA; verifying validity of an SM certificate received from a DCAS SM, and authenticating an SM; generating a session key being a symmetric key for secure communication of a corresponding DCAS SM when SM authentication of the SM certificate is completed; and transmitting an SM authentication response using the generated session key.

According to still another aspect of the present invention, there is provided a method of controlling a TA in a mutual authentication method in a digital cable broadcasting network, the method including: issuing, by the TA, an SM certificate with respect to a DCAS SM, and storing list information about the DCAS SM in a DCAS SM key pairing database (DB); receiving an SM certificate request message from the DCAS SM; searching for the DCAS SM key pairing DB based on the received message, and verifying validity of a requested DCAS SM; and issuing the SM certificate signed by a private key of a TA to the DCAS SM based on a result of the verifying.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 illustrates an overview of a network of a Downloadable Conditional Access System (DCAS) in a digital cable broadcasting network according to an exemplary embodiment of the present invention;

FIG. 2 illustrates main management information of servers in a mutual authentication method in a digital cable broadcasting network according to an exemplary embodiment of the present invention;

FIG. 3 illustrates an example of a configuration form of an X.509 certificate used by a DCAS Secure Micro (SM) and an Authentication Proxy (AP) Server according to an exemplary embodiment of the present invention;

FIG. 4 is a block diagram illustrating an apparatus for controlling a DCAS SM in a mutual authentication method in a digital cable broadcasting network according to an exemplary embodiment of the present invention;

FIG. 5 is a block diagram illustrating an AP server in a mutual authentication method in a digital cable broadcasting network according to an exemplary embodiment of the present invention;

FIG. 6 is a flowchart illustrating a process of performing mutual authentication between a DCAS SM and an AP server in a mutual authentication method in a digital cable broadcasting network according to an exemplary embodiment of the present invention; and

FIG. 7 is a flowchart illustrating a mutual authentication process among a DCAS SM, an AP server, and a Trusted Authority (TA) in a mutual authentication method in a digital cable broadcasting network according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

When detailed descriptions related to a well-known related function or configuration are determined to make the spirits of the present invention ambiguous, the detailed descriptions will be omitted herein. Also, terms used throughout the present specification are used to appropriately describe exemplary embodiments of the present invention, and thus may be different depending upon a user and an operator's intention, or practices of application fields of the present invention. Therefore, the terms must be defined based on descriptions made through the present invention.

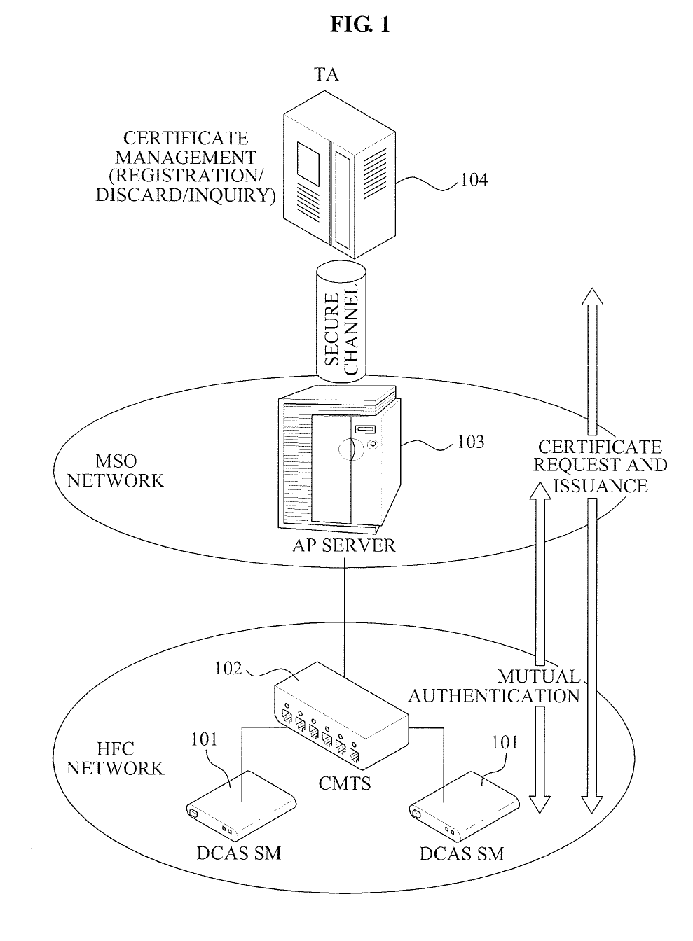

FIG. 1 illustrates an overview of a network of a Downloadable Conditional Access System (DCAS) in a digital cable broadcasting network according to an exemplary embodiment of the present invention.

Hereinafter, referring to FIG. 1, the network of the DCAS in the digital cable broadcasting network according to an exemplary embodiment of the present invention is described.

The network of the DCAS in the digital cable broadcasting network according to an exemplary embodiment of the present invention is based on an X.509 certificate, and includes a DCAS SM 101, a Cable Modem Termination System (CMIS) 102, an Authentication Proxy (AP) Server 103, a Trusted Authority (TA) 104, and the like. The present exemplary embodiment of the present invention is described below.

The DCAS SM 101 accesses a Hybrid Fiber Coax (HFC) network and is connected with the AP Server 103 of a headend system existing in an internal network of a Multiple System Operator (MSO) joined by the DCAS SM as a member of the MSO using the CMTS 102.

Since the DCAS SM 101 performs mutual authentication with the AP Server 103 and distributes a key in order to securely download and drive CAS client software for a DCAS service, secure communication is necessary. For this, the DCAS SM 101 requests a certificate for the mutual authentication with the AP server 103 to be issued, and requests SM authentication based on the issued certificate.

The CMTS 102 performs various cable modem (CM) card supports and modem authentication for an interface and a CM supporting two-way communication of the DCAS SM 101, and performs only a gateway function for providing a network interface of the HFC network and an MSO network.

The AP server 103 generates a secure communication channel with the TA 104 of a third party to issue and manage the certificate with respect to all DCAS SMs, and transceives information using the secure channel.

The TA 104 first issues an SM certificate with respect to the DCAS SM 101, and stores list information about the DCAS SM 101 in a DCAS SM key pairing database (DB). When an SM certificate request message is subsequently received from the DCAS SM 101, the TA 104 searches for the DCAS SM key pairing DB based on the received message, verifies validity of a requested DCAS SM, and issues the SM certificate signed by a private key of the TA 104 to the DCAS SM 101 based on a result of the verifying.

The verifying of validity and issuing of the SM certificate by the TA issues the SM certificate signed by the private key of the TA and transmits the SM certificate along with the same timestamp included in the SM certificate request message, using an Identification number (ID) assigned to the DCAS SM 101, a public key, and information of an AP server, the information including an Internet Protocol (IP) address or user@realm.

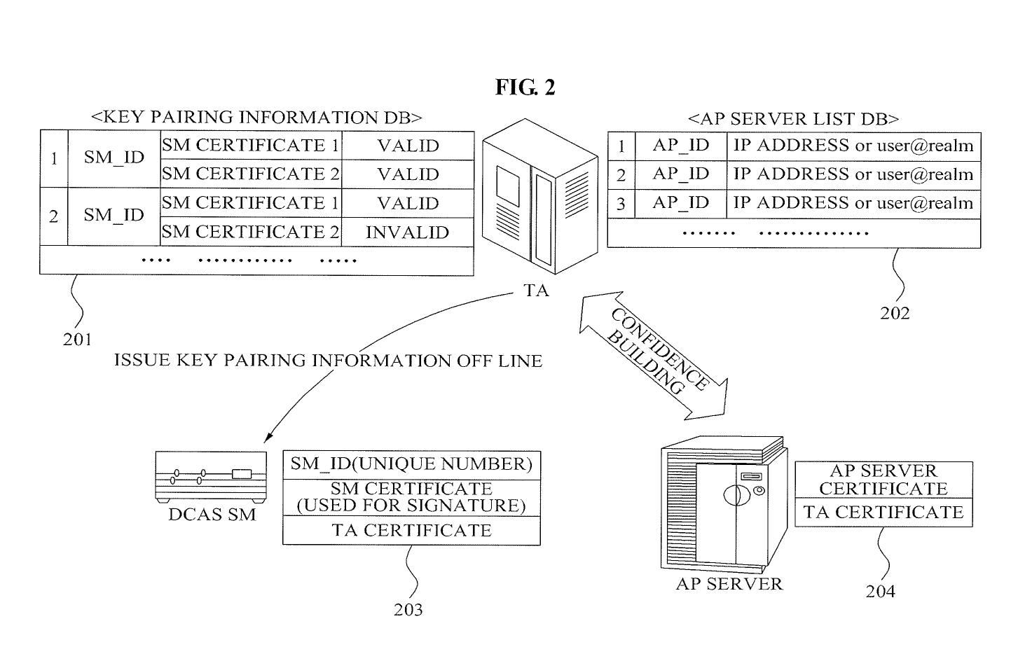

FIG. 2 illustrates main management information of each server directly participating for mutual authentication in a mutual authentication method in a digital cable broadcasting network according to an exemplary embodiment of the present invention, and mutual authentication starts based on the information.

Hereinafter, referring to FIG. 2, the main management information of each server directly participating for mutual authentication in the mutual authentication method in the digital cable broadcasting network according to an exemplary embodiment of the present invention is described.

The main management information stored by each server of a DCAS in the digital cable broadcasting network includes a DCAS SM key pairing DB 201 including information about a DCAS SM, the information being stored by the TA, an AP server list DB 202 including information about an AP server, information 203 stored in the DCAS SM, information 204 stored in the AP server, and the like.

The TA 104 issues an SM certificate with respect to all the DCAS SMs 101, and stores list information about the DCAS SM 101 in the key pairing DB 201. In this instance, the TA 104 issues an ID (SM_ID) assigned to each DCAS SM 101 when manufacturing the DCAS SM 101, and a certificate (an SM certificate), and verifies whether each certificate issued while providing a DCAS service is valid, and stores and manages a result of the verifying.

When an authentication request is performed using an invalid certificate from among SM certificates managed by the TA 104, or when an authentication request of a certificate that is not issued and is not managed is performed, the TA 104 enables normal authentication not to be performed.

The TA 104 needs message exchange related to authentication with the DCAS AP server 103. For this, the TA 104 constructs a secure communication channel in advance, stores information related to the secure communication channel in the AP server list DB 202, and manages identification information about the AP server transmitted using the secure communication channel. Accordingly, which AP server 103 enables messages currently transmitted to the TA 104 to be transceived may be determined.

In the AP server list DB 202 including the information about the AP server, mapping of the identification information (AP_ID) allocated in order to classify each AP server, and an Internet address (an IP address, user@realm, and the like) being unique information of the AP server with network information of a communication channel of each AP server may be performed. Various methods of composing the secure communication channel between the TA and the AP server such as a Secure Sockets Layer (SSL) and an IP security protocol (IPSec) exist.

The DCAS SM 101 manages the information issued from the TA 104 when manufacturing the DCAS SM 101 (SM_ID being the ID of the DCAS SM 101, the SM certificate used for a signature, and a TA certificate) in a secure storage area 203 having a copying prevention function. The SM certificate (used for the signature) issued when manufacturing the DCAS SM 101 is used for a message signature for an issuance request of the certificate to perform authentication with the AP server 103 after the ID of the DCAS SM 101 (SM_ID) is transmitted to the TA 104 and it is proved that the DCAS SM 101 is a permitted owner of the ID (SM_ID). The TA certificate is used for verification with respect to all certificates issued from the TA.

The AP server 103 stores the TA certificate and an AP server certificate of the AP server 103, the AP server certificate being issued from the TA 104 (204). The AP server certificate is transmitted to the DCAS SM 101 in order to verify whether the AP server 103 is valid when the DCAS SM 101 performs mutual authentication. The TA certificate is used for verification with respect to all DCAS SM certificates issued from the TA 104.

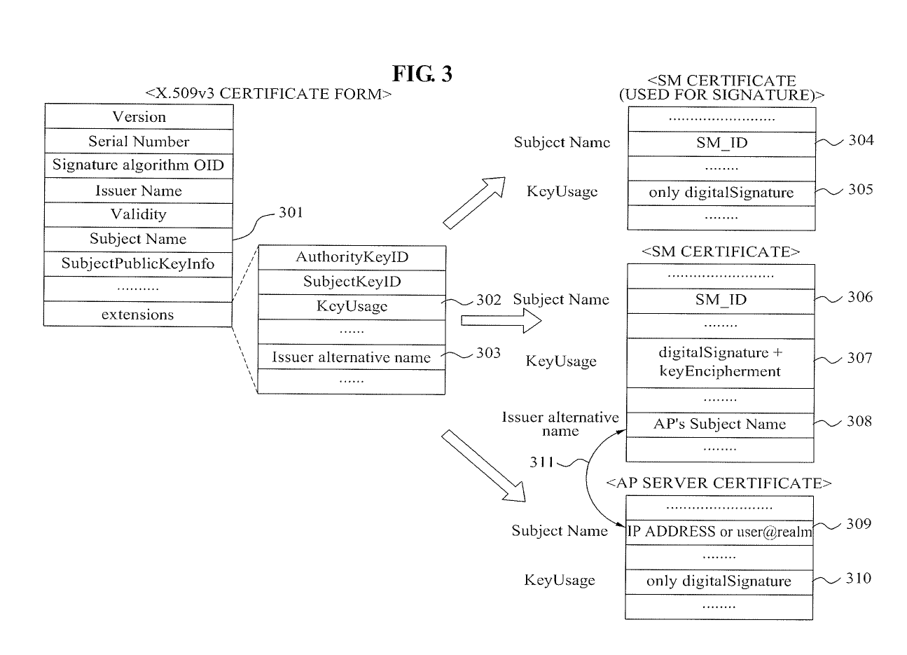

FIG. 3 illustrates an example of a configuration form of an X.509 certificate used by a DCAS SM and an AP server according to an exemplary embodiment of the present invention.

Hereinafter, referring to FIG. 3, the configuration form of the X.509 certificate used by the DCAS SM and the AP server according to an exemplary embodiment of the present invention is described.

The X.509 certificate is a digital certificate standard, and a digital certificate is a sort of “electronic credit cards” of establishing a qualification of a user when performing business or other transactions on a web. This is issued from a certificate authority and includes an owner's name, a serial number, a valid period, a public key copy of a certificate owner (used for encryption and restoration of a message or a digital signature), a digital signature of a certificate issuance authority, and the like so that a recipient may verify whether the certificate is genuine or counterfeit. This may be stored in a registration area so that authenticated users may see public keys of other users.

The X.509 version (v) 3 certificate used for the present invention is a format being currently and most widely used, and generally includes main information illustrated in Table 1.

TABLE 1

| Field name | Contents |
|---|---|
| Version | X.509 certificate form version |
| Serial Number | Serial Number allocated each time the |
| | certificate authority issues the certificate |
| Signature algorithm Object | Type of Rivest Shamir Adleman (RSA) |
| Identifier (OID) | digital signature algorithm used by the |
| | certificate authority |
| Issuer Name | Name of the certificate authority |
| Validity | Valid period of the certificate (From/To) |
| Subject Name | Distinguished Name (DN) of |
| | authentication subject of the certificate |
| | issued from the certificate authority |
| SubjectPublicKeyInfo | Public key information of subject |
| | (public key, algorithm type, key length) |

In addition to the above-described contents, v3 includes an extensions field, and defines fields to include information additionally used for the certificate. The present invention generally follows a field used for generating the certificate of the DCAS SM 101, and a use range without changing a usage, however, the identification information of the AP server is charactertistically stored and used in an Issuer alternative name field 303 composing the extensions field.

The TA 104 uses the ID of the DCAS SM 101 (SM_ID) for a subject name field 301 when generating and issuing the SM certificate of the DCAS SM 101, and defines a range based on a key usage included in each certificate in KeyUsage fields 305, 307, and 310.

When the DCAS SM 101 transmits an SM certificate issuance request message for mutual authentication with the AP server 103, the TA 104 enables an Internet address (an IP address or user@realm) to be included in the Issuer alternative name field 303 and to be issued, the Internet address being the identification information of the AP server when generating the SM certificate. The DCAS SM 101 compares AP server identification information 308 of the Issuer alternative name field 303 included in the SM certificate of the DCAS SM 101, and a Subject Name 309 of the AP server certificate received from the AP server 103 (311), and enables validity of the AP server to be verified.

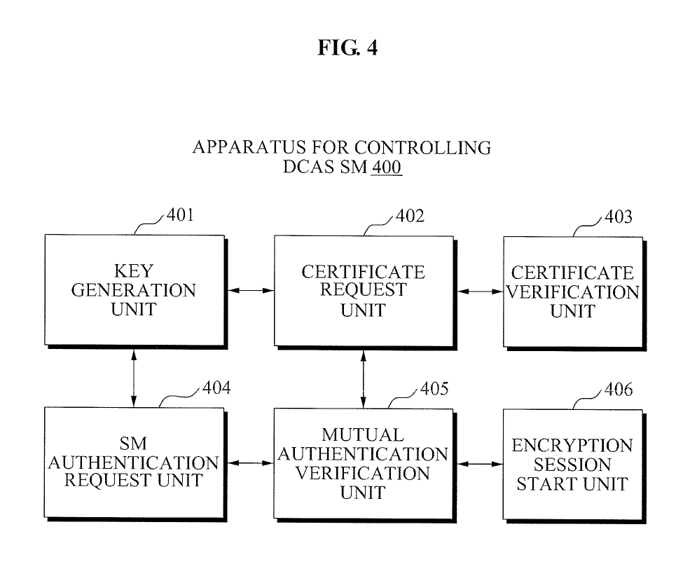

FIG. 4 is a block diagram illustrating an apparatus 400 for controlling a DCAS SM in a mutual authentication method in a digital cable broadcasting network according to an exemplary embodiment of the present invention.

Hereinafter, referring to FIG. 4, a configuration and a function of the apparatus 400 for controlling the DCAS SM in the mutual authentication method in the digital cable broadcasting network according to an exemplary embodiment of the present invention are described.

The apparatus 400 for controlling the DCAS SM includes a key generation unit 401, a certificate request unit 402, a certificate verification unit 403, an SM authentication request unit 404, a mutual authentication verification unit 405, an encryption session start unit 406, and the like.

The key generation unit 401 generates a public key and a private key as one pair, using an RSA algorithm. Here, RSA is an Internet encryption and authentication system for using an algorithm developed by Ron Rivest, Adi Shamir, and Leonard Adleman in 1977. The RSA algorithm is the most widely-used encryption and authentication algorithm, and is included as a portion of a Netscape and Microsoft web browser function. Theses technologies generate a portion of webs, the Internet, and computing standards being already disclosed and proposed.

An operating principle of the RSA algorithm accompanies an operation of inducing a number system of two sets of which a set is used for composing a public key and another set is used for composing a private key, using multiplication and additional calculation of two large prime numbers (a prime number denoting a number that may be divided only by itself and 1). When the keys are generated once, an original prime number is unimportant, and both the public key and the private key are necessary for encryption/decryption.

The private key is used for decrypting a text encrypted by the public key. Accordingly, when a situation where one transmits a message to someone else is assumed, one may encrypt the message transmitted using the public key after finding the public key of a receiver from a center operator. The receiver receives the message and decrypts the message using one's own private key. One may convince the receiver that the message is surely transmitted from the same one person by encrypting the message in order to ensure privacy, and encrypting and transmitting a digital signature using one's own private key. The receiver having received the message may decrypt the message using the public key of the transmitter.

The certificate request unit 402 requests a TA 103 to issue an SM certificate via a secure communication channel of the AP server 103 using the keys generated by the key generation unit 401.

The certificate request unit 402 appends a signature value SIGN_{SMK} including each of an SM ID (SM_ID), the generated public key (SM-pub), a timestamp, and the private key (SMK) of the SM certificate (used for a signature) being issued and being stored when manufacturing the SM, and requests the TA to issue the SM certificate using the SM ID, the generated public key, the timestamp, and the private key of the SM certificate.

The certificate verification unit 403 verifies whether the SM certificate issued from the TA by the certificate request unit 402 via the secure communication channel is forged or altered using a TA certificate included in the DCAS SM.

The SM authentication request unit 404 transmits an SM authentication request message to the AP server based on the SM certificate for which the verifying is completed in the certificate verification unit 403. In this case, the transmitting further includes a variable of a predetermined length for preventing a message retransmission attack and a signature value SIGN_{SM-pri} for preventing forgery or alteration of a message in addition to the SM certificate.

The mutual authentication verification unit 405 compares first AP server identification information and second AP server identification information included in the SM certificate issued from the TA 104 to the DCAS SM 101 by referring to an AP server certificate included in an SM authentication response message received from the AP server 103, verifies whether the first and second AP server identification information are the same, and completes mutual authentication.

The encryption session start unit 406 starts an encryption session of enabling message encryption/decryption between the DCAS SM 101 and the AP server 103 using a session key included in the SM authentication response message after the mutual authentication verification unit 405 completes mutual authentication.

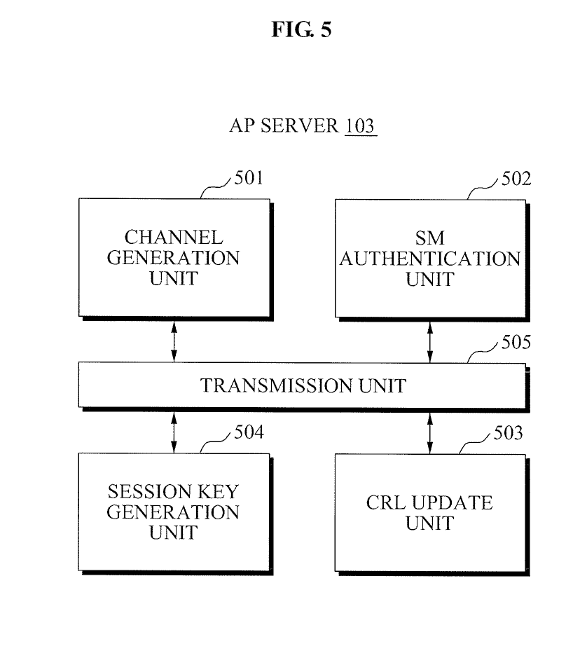

FIG. 5 is a block diagram illustrating an AP server 103 in a mutual authentication method in a digital cable broadcasting network according to an exemplary embodiment of the present invention.

Hereinafter, referring to FIG. 5, a configuration and a function of the AP server 103 in the mutual authentication method in the digital cable broadcasting network according to an exemplary embodiment of the present invention are described.

The AP server 103 according to an exemplary embodiment of the present invention includes a channel generation unit 501, an SM authentication unit 502, a Certification Revocation List (CRL) update unit 503, a session key generation unit 504, a transmission unit 505, and the like.

The channel generation unit 501 enables the AP server 103 to generate a secure communication channel with the TA 104. Since there are various methods of generating the secure communication channel including an SSL, an IPSec, and the like, a correlation between each secure communication channel and the AP server list DB 202 may be regarded as a difference of various embodiment methods in the present invention. Accordingly, the present invention would be easily appreciated and embodied by those skilled in the art using the present specification even when this is not described in detail.

The SM authentication unit 502 verifies validity of an SM certificate received from the DCAS SM 101 and authenticates an SM. The AP server 103 stores information 204 including a TA certificate and an AP server certificate of the AP server, the AP server certificate being issued from the TA 104, verifies the validity of the SM certificate received from the DCAS SM, and authenticates the SM using a TA certificate stored in the AP server 103 and CRL information.

The CRL update unit 503 enables the AP server 103 to update, with the TA 104, newest information about CRL information transmitted regularly or irregularly (each time change information is generated).

The session key generation unit 504 generates a session key being a symmetric key for secure communication of a corresponding DCAS SM when SM authentication of the SM certificate is completed.

The transmission unit 505 transmits an SM authentication response using the session key generated by the session key generation unit 404. In this instance, the transmission unit 505 encrypts (E_{SM-pub}) the session key and the SM certificate using a public key of the SM certificate (SM-pub) for which authentication is completed, and transmits the SM authentication response along with a message signature.

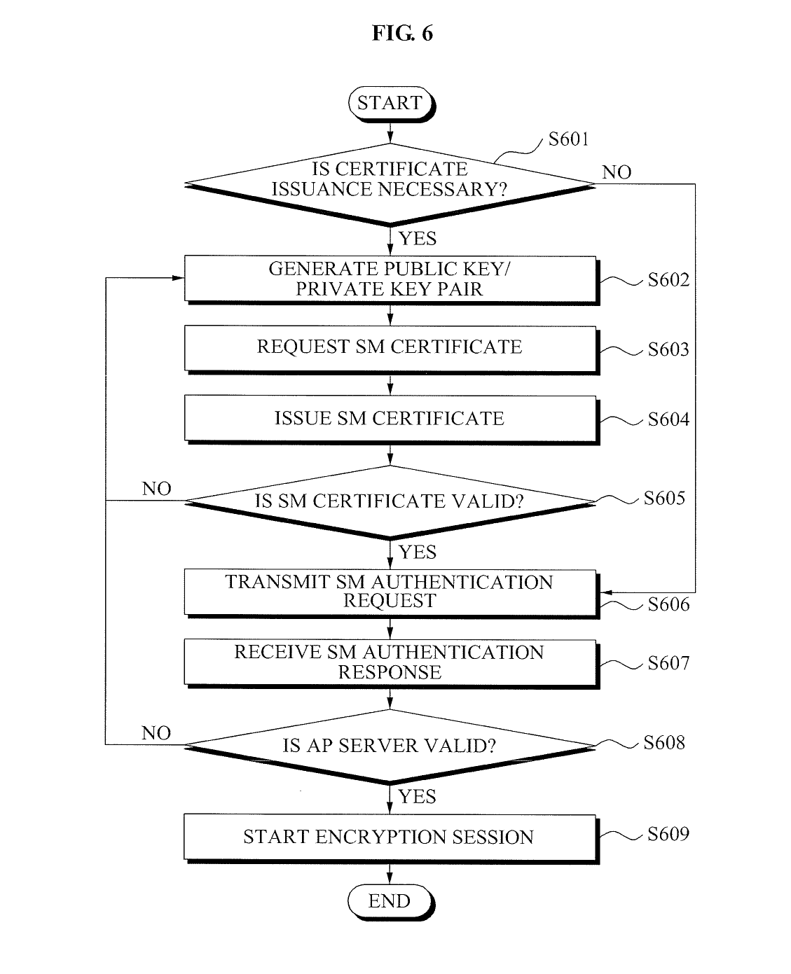

FIG. 6 is a flowchart illustrating a process of performing mutual authentication between a DCAS SM and an AP server in a mutual authentication method in a digital cable broadcasting network according to an exemplary embodiment of the present invention.

Hereinafter, the process during which the DCAS SM 101 normally requests an SM certificate, the SM certificate is issued, and performs mutual authentication with the AP server using the SM certificate is described.

When the DCAS SM 101 initially accesses a cable network (an HFC network) or turns on power, the DCAS SM 101 verifies a broadcasting message received from the AP server 103, performs downloading for SM client reinstallation or compares identification information of the AP server, and starts authentication using a following process when authentication based on network movement is determined to be necessary.

In operation S601, the DCAS SM 101 verifies a certificate state currently possessed by the DCAS SM 101 for authentication with the AP server 103, and determines whether certificate issuance or update is necessary.

In operation S606, when the first identification information are same as the second identification information of the AP server 103 to currently perform mutual authentication referring to a certificate being already issued and being already stored and a valid period remains, reuse is possible, a certificate issuance request process is omitted, and an SM authentication request is immediately performed.

However, in operation S602, when certificate issuance is necessary, the method generates a public key/private key pair using an RSA key generation algorithm. In operation S603, the method requests an SM certificate based on the generated public key information and the identification information of the DCAS SM 101. The SM certificate being issued from the TA 104 and being received in operation S604 verifies validity of the SM certificate using a TA certificate included in the DCAS SM 101 in operation S605.

In operation S606, when validity of the issued SM certificate is verified, the method transmits the SM authentication request to the AP server 103 to perform secure communication with the DCAS SM 101. In operation S607, the method receives an authentication result with respect to the SM authentication request along with an encrypted session key. In operation S608, the method verifies an AP server certificate of the AP server included when receiving an SM authentication response. In operation S609, the method permits session key use.

When the AP server certificate of the AP server is invalid, the AP server certificate is different from AP server information in the SM certificate issued to the DCAS SM 101, or the AP server certificate is forged or altered. Accordingly, since using the session key received from the AP server causes security hazard, the method reattempts operations S602 through S608 from an SM certificate issuance request operation.

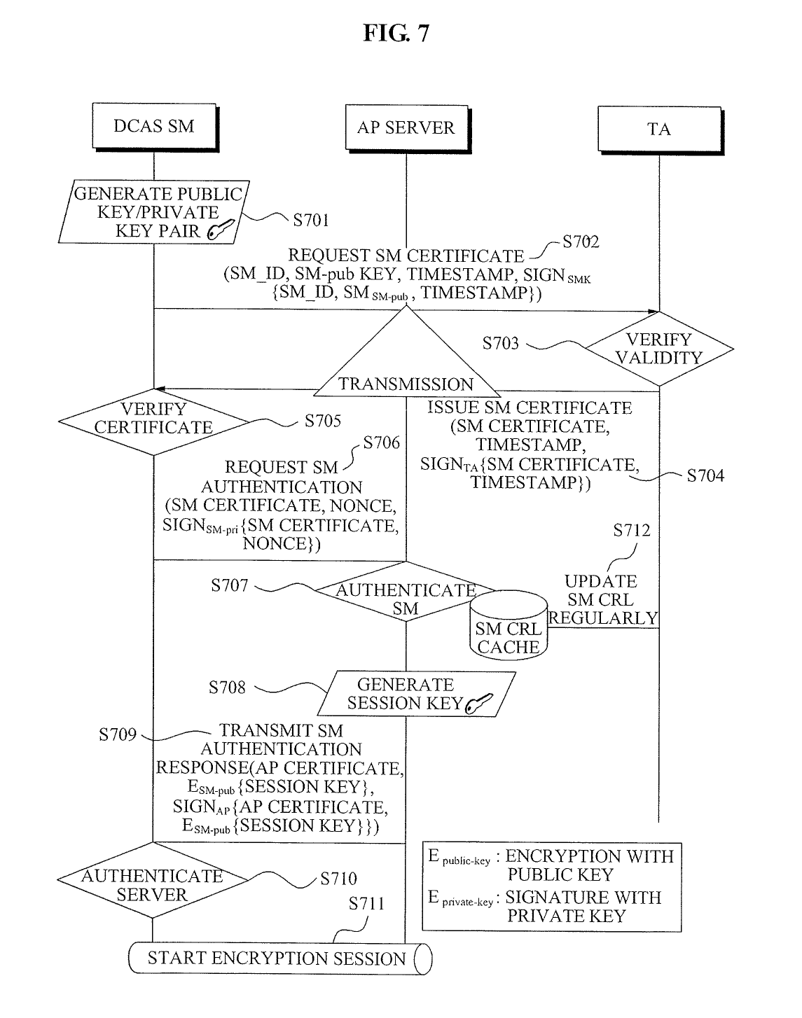

FIG. 7 is a flowchart illustrating a mutual authentication process among a DCAS SM, an AP server, and a TA in a mutual authentication method in a digital cable broadcasting network according to an exemplary embodiment of the present invention, and each message flow indicates a message name used among subjects transceiving a message and a main parameter.

When the DCAS SM 101 supporting a downloadable Conditional Access (CA) service joins a cable broadcasting service and intends to normally watch a video, a software program related to CA such as a Conditional Access System (CAS) client must be downloaded from a cable network of an MSO joining the cable broadcasting service, and must be installed and driven in the DCAS SM 101. In this case, the DCAS SM 101 requires an SM certificate of the DCAS SM 101 in order to issue and update a key for authentication. In operation S701, when the SM certificate must be newly issued or be reissued, the method generates a public key/private key pair using an RSA algorithm being a representative public key-based algorithm. For example, the generated public key/private key of the DCAS SM 101 may be defined as an SM-pub key and an SM-pri key.

The DCAS SM 101 subsequently transmits an ID of the DCAS SM 101 (SM_ID) and the generated public key (SM-pub), and a timestamp to the TA 104, and requests a certificate to be issued. In operation S702, the method appends and transmits a signature value SIGN_{SMK} including an ID of the DCAS SM 101 (SM_ID), the SM public key (SM-pub), and the timestamp, using the private key (SMK) of the SM certificate (used for a signature) being issued and being stored when manufacturing the SM. The timestamp is used for preventing a malicious hacker from performing a message retransmission attack to the TA 104 using the SM certificate request message in operation S702, and the signature value SIGN_{SMK} enables the DCAS SM 101 to report SM_ID of the DCAS SM 101, and proves that the DCAS SM 101 is a legitimate SM having a certificate (used for a signature) issued by the TA 104.

The AP server 103 transmits the SM certificate request message in operation S702 received from the DCAS SM 101 to the TA 104 without a message change using a secure communication channel.

In operation S703, the TA 104 having received the SM certificate request message searches for the DCAS SM key pairing DB 201 described with reference to FIG. 2, and verifies validity of the DCAS SM 101 requested by the DCAS SM 101 using the SM certificate request message. The method issues the SM certificate signed by the private key of the TA 104 to the DCAS SM 101, transmits the SM certificate along with the same timestamp included in the SM certificate request message, and appends a message signature value using the private key of the TA 104, thereby ensuring message integrity. In operation S704, the SM certificate includes SM_ID, the public key, the identification information of the AP server (an IP address or user@realm), and the like.

In operation S705, the DCAS SM 101 for which the SM certificate is issued from the TA 104 verifies whether the SM certificate is forged or altered using a TA certificate included in the DCAS SM 101. Accordingly, security vulnerability with respect to exposure of information about the DCAS SM 101, the exposure occurring when an invalid certificate is issued or used from an illegitimate AP server or an illegitimate certificate authority, may be prevented. The DCAS SM 101 acquires actual information of the AP server 103 from the SM certificate issued from the TA 104 so that the DCAS SM 101 may perform mutual authentication with the AP server 103.

In operation S706, the method subsequently transmits an SM authentication request message to the AP server 103 based on the SM certificate, and the transmitting further includes a variable of a predetermined length for preventing a message retransmission attack and a signature value SIGN_{SM-pri} for preventing forgery or alteration of a message in addition to the SM certificate.

In operation S707, the AP server 103 having received the SM authentication request message verifies the validity of the SM certificate received from the DCAS SM 101, and authenticates the DCAS SM 101 using a TA certificate and CRL information. In operation S712, the AP server 103 updates newest information about the CRL information with the TA 104 regularly or irregularly (each time change information is generated). Accordingly, SM certificate validity verification simultaneously and frequently occurring may be quickly dealt with in real time.

In operation S708, when the AP server 103 completes SM authentication of the SM certificate, the method generates a session key being a symmetric key for secure communication of a corresponding DCAS SM. In operation S709, the method encrypts (E_{SM-PUb}) the session key and the SM certificate using a public key (SM-pub) of the SM certificate for which authentication is completed, and transmits the SM authentication response along with a message signature.

In operation S710, the DCAS SM 101 comparing first AP server identification information and second AP server identification information included in the SM certificate issued from the TA 104 by referring to the AP server certificate included in the SM authentication response message in operation S709, verifies whether the first and second AP server identification information are the same, and completes mutual authentication. In operation S711, an encryption session of enabling message encryption/decryption between the DCAS SM 101 and the AP server 103 using the session key included in the SM authentication response message in operation S709 starts.

The mutual authentication method in the digital cable broadcasting network according to an exemplary embodiment of the present invention illustrated with reference to FIG. 6 and FIG. 7 does not necessarily perform a consecutive process sequentially, and a sequence of a control method may be variously performed.

A method and apparatus of X.509 certificate-based mutual authentication and key distribution for the DCAS in the digital cable broadcasting network according to the above-described exemplary embodiments may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to the present invention, it is possible to solve security vulnerability occurring based on a characteristic of mutual authentication on line between systems and a software transmission scheme. This is a scheme of generating a secure channel between interested parties and enabling communication using on-line mutual authentication, and is performed by public key-based secure communication, and the public key-based secure communication enables secure secret communication by registering one's public key using a TA of a third party and reliably distributing one's own public key to a counterpart intending to use the own public key.

Also, according to the present invention, it is possible to enhance a security strength using mutual authentication for secure communication between an AP server and an SM composing a headend system for downloadable CA in a digital cable broadcasting network by selecting an X.509 certificate-based mutual authentication and key distribution scheme.

Also, according to the present invention, it is possible to verify validity of an SM certificate simultaneously and frequently occurring and perform real-time mutual authentication based on newest information since an AP server updates newest information about CRL information with a TA regularly or irregularly (each time change information is generated).

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of controlling a downloadable Conditional Access (CA) Secure Micro (SM) in a mutual authentication method in a digital cable broadcasting network, the method comprising:
generating, by the downloadable CA SM, a public key and a private key as one pair, using a specific algorithm;
requesting a Trusted Authority (TA) to issue an SM certificate via a secure communication channel of an Authentication Proxy (AP) Server using the generated keys;
verifying whether the SM certificate issued from the TA via the secure communication channel is forged or altered using a TA certificate included in the downloadable CA SM;
transmitting an SM authentication request message to the AP server based on the SM certificate for which the verifying is completed; and
comparing first AP server identification information and second AP server identification information included in the SM certificate issued from the TA and verifying whether the first and second AP server identification information are the same using an SM authentication response message received from the AP server.

2. The method of claim 1, further comprising:
downloading CA system client software from a cable network of a Multiple System Operator (MSO) network being a member of a cable broadcasting service.

3. The method of claim 1, wherein the downloadable CA SM stores information including an SM Identification number (ID) issued from the TA when manufacturing the SM, the SM certificate, and the TA certificate.

4. The method of claim 1, wherein the requesting appends a signature value including each of an SM ID, the generated public key, a timestamp, and the private key of the SM certificate being issued and being stored when manufacturing the SM, and requests the TA to issue the SM certificate using the SM ID, the generated public key, the timestamp, and the private key of the SM certificate.

5. The method of claim 1, wherein the transmitting further includes a variable of a predetermined length for preventing a message retransmission attack and a signature value for preventing forgery or alteration of a message in addition to the SM certificate.

6. The method of claim 1, wherein the specific algorithm is a Rivest Shamir Adleman (RSA) algorithm.

7. The method of claim 1, wherein the downloadable CA SM is based on a certificate and is connected with a Cable Modem Termination System (CMTS) using a Hybrid Fiber Coax (HFC) network.

8. A method of controlling an AP server, the method comprising:
generating, by the AP server, a secure communication channel with a TA;
verifying validity of an SM certificate received from a downloadable CA SM, and authenticating an SM;
generating a session key being a symmetric key for secure communication of a corresponding downloadable CA SM when SM authentication of the SM certificate is completed; and
transmitting an SM authentication response using the generated session key.

9. The method of claim 8, wherein the verifying and authenticating verifies the validity of the SM certificate received from the downloadable CA SM, and authenticates the SM using a TA certificate stored in the AP server and Certification Revocation List (CRL) information.

10. The method of claim 8, wherein the transmitting encrypts the session key and the SM certificate using a public key of the SM certificate for which authentication is completed, and transmits the SM authentication response along with a message signature.

11. The method of claim 8, further comprising:
updating, by the AP server, newest information about CRL information with the TA regularly or irregularly.

12. The method of claim 8, wherein the AP server stores information including a TA certificate and an AP server certificate of the AP server, the AP server certificate being issued from the TA.

13. A method of controlling a TA in a mutual authentication method in a digital cable broadcasting network, the method comprising:
issuing, by the TA, an SM certificate with respect to a downloadable CA SM, and storing list information about the downloadable CA SM in a downloadable CA SM key pairing database (DB);
receiving an SM certificate request message from the downloadable CA SM;
searching for the downloadable CA SM key pairing DB based on the received message, and verifying validity of a requested downloadable CA SM; and
issuing the SM certificate signed by a private key of a TA to the downloadable CA SM based on a result of the verifying.

14. The method of claim 13, wherein the issuing of the SM certificate signed by the private key of the TA issues the SM certificate signed by the private key of the TA and transmits the SM certificate along with the same timestamp included in the SM certificate request message, using an ID assigned to the downloadable CA SM, a public key, and information of an AP server, the information including an Internet address.

15. The method of claim 13, wherein the TA stores ID information allocated for classifying each AP server and information of the AP server including an Internet address.

16. The method of claim 13, wherein the list information stored by the downloadable CA SM key pairing information DB includes an ID assigned to each downloadable CA SM when manufacturing the downloadable CA SM, the SM certificate, and information about whether each certificate issued during a downloadable CA service period is valid.
